(19) United States
(12) Patent Application Publication
(10) Pub. No.: US 2023/0113106 A1
(43) Pub. Date: Apr. 13, 2023

(54) INFORMATION PROCESSING APPARATUS, INFORMATION PROCESSING METHOD AND STORAGE MEDIUM STORING PROGRAM

(71) Applicant: Geocreates, Inc., Tokyo (JP)

(72) Inventor: Tsukasa Honda, Tokyo (JP)

(21) Appl. No.: 18/080,956

(22) Filed: Dec. 14, 2022

Related U.S. Application Data
(63) Continuation of application No. PCT/JP2021/020795, filed on Jun. 1, 2021.

(30) Foreign Application Priority Data
Jun. 18, 2020 (JP) 2020-105134

(51) Int. Cl. G06Q 50/16; G06F 3/0482; G06F 3/01

(52) U.S. Cl. CPC G06Q 50/163; G06F 3/0482; G06F 3/017

(57) ABSTRACT

An information processing apparatus includes: an information acquiring part that acquires selected image identification information for identifying one or more selected images selected from a plurality of space images, corresponding to a plurality of regions in a space to be looked at from a plurality of positions in the space, by a viewer who views the plurality of space images; a viewing state specifying part that specifies a viewing time of each of the one or more selected images selected by the viewer; and an output part that outputs one or more thumbnail images corresponding to the one or more selected images in a manner corresponding to the viewing time.

### CROSS-REFERENCE TO RELATED APPLICATIONS

The present application is a continuation application of International Application number PCT/JP2021/020795, filed on Jun. 1, 2021, which claims priority under 35 U.S.C § 119(a) to Japanese Patent Application No. 2020-105134, filed on Jun. 18, 2020, contents of which are incorporated herein by reference in their entirety.

### BACKGROUND OF THE INVENTION

The present disclosure relates to an information processing apparatus, an information processing method, and a program for processing information about an image indicating an atmosphere of a space.

Conventionally, there has been known a technique of displaying a Virtual Reality (VR) image in which an indoor space such as a model home or store is reproduced in a virtual space, and causing a viewer to have an experience as if he/she walks in an actual indoor space (see, for example, Japanese Unexamined Patent Application Publication No. 2006-40053).

In a case where a customer visits a model home, a store, or the like, a person in charge of sales can grasp what kind of impression the customer has for a building, a space, or a product (which may be referred to hereinafter as “products or the like”) placed in the space, by providing an explanation while observing the customer. However, if the customer views an image represented in a virtual space, a large number of people can view products or the like compared to the case of an actual model home, store, or the like, but a person in charge of a company selling products or the like has difficulty grasping what kind of impression the customer has for the products or the like.

### BRIEF SUMMARY OF THE INVENTION

The present disclosure focuses on this point, and its object is to provide an information processing apparatus, an information processing method, and a program for making it easier to grasp what kind of impression the customer has for a predetermined building, space, or product in the space.

An information processing apparatus according to a first aspect of the present disclosure includes: an information acquiring part that acquires selected image identification information for identifying one or more selected images selected from a plurality of space images, corresponding to a plurality of regions in a space to be looked at from a plurality of positions in the space, by a viewer who views the plurality of space images; a viewing state specifying part that specifies a viewing time of each of the one or more selected images selected by the viewer; and an output part that outputs one or more thumbnail images corresponding to the one or more selected images in a manner corresponding to the viewing time.

An information processing method according to a second aspect of the present disclosure, executed by a computer, includes the steps of: acquiring selected image identification information for identifying one or more selected images selected from a plurality of space images, corresponding to a plurality of regions of a space to be looked at from a plurality of positions in the space, by a viewer who views the plurality of space images; specifying a viewing time of each of the one or more selected images selected by the viewer; and outputting one or more thumbnail images corresponding to the one or more selected images in a manner corresponding to the viewing time.

A non-transitory storage medium storing a program according to a third aspect of the present disclosure stores a program for causing a computer to function as: an information acquiring part that acquires selected image identification information for identifying one or more selected images selected from a plurality of space images, corresponding to a plurality of regions in a space to be looked at from a plurality of positions in the space, by a viewer who views the plurality of space images; a viewing state specifying part that specifies a viewing time of each of the one or more selected images selected by the viewer; and an output part that outputs one or more thumbnail images corresponding to the one or more selected images in a manner corresponding to the viewing time.

### BRIEF DESCRIPTION OF THE DRAWINGS

FIG. 1 shows an outline of an information processing system.

FIG. 2 shows a configuration of an information processing apparatus.

FIG. 3 shows an example of an image output by an output part.

FIGS. 4A to 4C show other examples of thumbnail images output by the output part.

FIGS. 5A and 5B show an example of a screen including thumbnail images and a layout diagram displayed by an administrator terminal.

FIGS. 6A and 6B show an example of a screen including thumbnail images and a layout diagram displayed by the administrator terminal.

FIG. 7 shows an example of a weekly analysis result output by the output part.

FIG. 8 is a sequence diagram showing a flow of processing in the information processing system.

### DETAILED DESCRIPTION OF THE INVENTION

Hereinafter, the present disclosure will be described through exemplary embodiments, but the following exemplary embodiments do not limit the invention according to the claims, and not all of the combinations of features described in the exemplary embodiments are necessarily essential to the solution means of the invention.

### Outline of the Information Processing System S

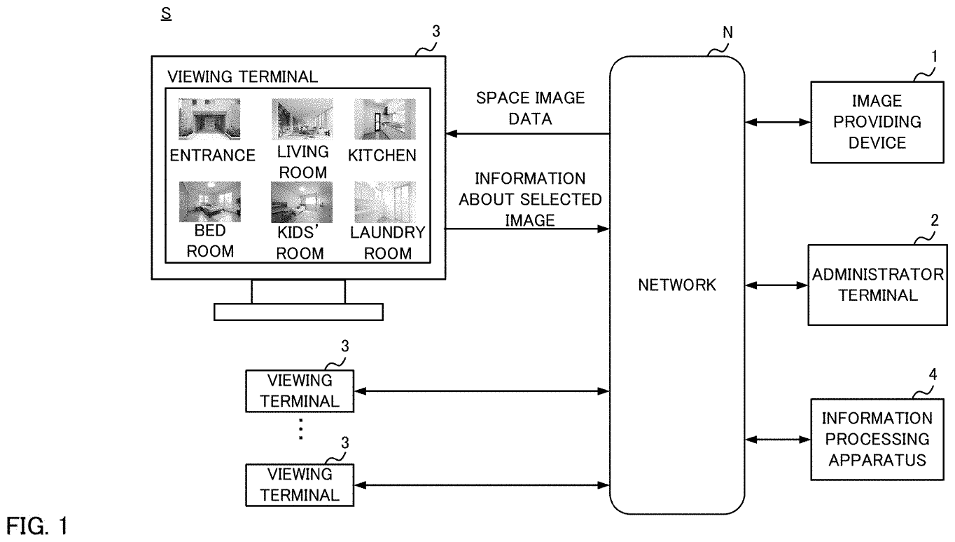

FIG. 1 shows an outline of an information processing system S. The information processing system S is a system that enables a viewer to view a plurality of space images indicating a state where a space is viewed, and makes it possible to analyze the state of the viewer who viewed the plurality of space images. The viewer is a person who is to view the plurality of space images corresponding to a plurality of regions in the space that are looked at from a plurality of positions in the space. The state of the viewer is represented by, for example, a time for which the viewer viewed the space indicated by the space image viewed by the viewer or a product included in the space image, a point that the viewer looked at, an impression that the viewer has for a product or the like, or the viewer's emotion.

The information processing system S includes an image providing device 1, an administrator terminal 2, a viewing terminal 3, and an information processing apparatus 4. The image providing device 1, the administrator terminal 2, the viewing terminal 3, and the information processing apparatus 4 transmit and receive various types of data via a network N such as the Internet.

The plurality of space images are, for example, i) an image by which the viewer participates in a preliminary inspection for buying or renting real estate, such as a house or an office, ii) an image showing a space for buying products, such as a store or a showroom for selling products, or iii) an image showing a space for experiencing a service, such as a tourist site, an amusement park, or a museum. The space image is a virtual reality image (a VR image), and may be an image generated by actually photographing a space in a building, or an image created by using computer graphics, for example.

The image providing device 1 is a server that stores a plurality of space images to be viewed by the viewer. The image providing device 1 is managed by an operator that manages a model home, a real estate company, or a store selling products, for example.

The image providing device 1 provides data indicating the plurality of space images (that is, space image data) to the viewing terminal 3 used by the viewer in a mode available for the viewer to view the plurality of space images via a web site described in a markup language, such as Hyper Text Markup Language (HTML). In this markup language, a script for the information processing apparatus 4 to transmit a situation in which the viewer views the plurality of space images is embedded.

In the script, a command for transmitting, for example, i) selected image identification information (hereinafter referred to as a “selected image ID”) for identifying a space image displayed by the viewing terminal 3, ii) viewing time information indicating a viewing time during which each space image was displayed on the viewing terminal 3, iii) operation location information indicating a location that the viewer operated on the viewing terminal 3, or iv) looking state information indicating a point that the viewer looked at, is described. The script is provided to an operator who manages the image providing device 1 from an operator who manages the information processing apparatus 4, for example. The script may be formed as an API.

The administrator terminal 2 is a computer used by an administrator who manages the image providing device 1 or the plurality of space images. The administrator terminal 2 may be a computer used by an administrator who manages only a part of a plurality of web sites provided by the image providing device 1. The administrator terminal 2 uploads the plurality of space images stored by the administrator to the image providing device 1 via the network N.

Further, the administrator terminal 2 receives, from the viewing terminal 3, a result obtained by analyzing a result of the viewer viewing the plurality of space images, and outputs the received result. The output result includes information indicating which space image among the plurality of space images the viewer is interested in, or where the viewer looked at in the space image. By checking the output result, the administrator can provide an appropriate explanation for the viewer and improve the subject matter of the space image (e.g., a photographing position, a photographing direction, or composition).

The viewing terminal 3 is a terminal used by the viewer to view the plurality of space images, and is a computer, a smartphone, or a tablet, for example. The viewing terminal 3 may be a terminal owned by the viewer or a terminal prepared in a model home or a store. The viewing terminal 3 receives space image data indicating the space image by executing processing described in a markup language received from the image providing device 1, and displays the image based on the received space image data on a display.

When the viewer operates the viewing terminal 3 to access a website of a model home, a store or the like, the viewing terminal 3 displays the plurality of space images, which can be selected by the viewer. In the example shown in FIG. 1, the viewing terminal 3 displays a list of the plurality of space images, and if the viewer selects one space image among the plurality of space images, the viewing terminal 3 displays the selected space image. The viewing terminal 3 may display the space images one by one, and may switch the space image being displayed in response to the viewer selecting an icon for switching the space image to be displayed. If the space image is an image captured by a 360-degree camera, for example, the viewing terminal 3 may change a looking direction for the space image to be displayed on the basis of the operation by the viewer.

The viewing terminal 3 transmits, to the information processing apparatus 4, information indicating a state where the viewer is viewing the space image by executing the script embedded in the markup language transmitted from the image providing device 1. The viewing terminal 3 transmits, to the information processing apparatus 4, i) a selected image ID for identifying one or more selected images selected by the viewer from the plurality of space images, ii) viewing time information indicating a viewing time for which each space image was displayed on the viewing terminal 3, and iii) looking state information indicating a looked-at point (hereinafter referred to as a “gaze point”) that the viewer looked at in the space image, for example. The looking state information may further include a looking time, which is a time for which each gaze point was looked at. It should be noted that the viewing terminal 3 may use any means to specify a line-of-sight position, but the viewing terminal 3 specifies the line-of-sight position on the basis of a direction of the pupil in a captured image generated by photographing the viewer's eyes, for example.

The viewing terminal 3 may be provided with a biometric information acquiring device that acquires biometric information of the viewer who is viewing the space image. The biometric information is, for example, brain waves, heart beats, pulse waves, an amount of sweating, skin potential, or body temperature. The viewing terminal 3 transmits the acquired biometric information to the information processing apparatus 4. A timing at which the viewing terminal 3 transmits various types of information is arbitrary, but the viewing terminal 3 transmits various types of information at a time interval (e.g., 30 second interval) described in the script, or at an acquiring interval of a looking time (e.g., a 0.05 second interval acquired for a heat map of the looking time), for example.

The information processing apparatus 4 is a computer for analyzing a state where the space image is viewed on the basis of the selected image ID, the viewing time information, the looking state information, the biometric information or the like received from the viewing terminal 3. The information processing apparatus 4 displays the analysis result on the display, prints the analysis result, or transmits the analysis result to an external device. In the following description, the operation of transmitting the analysis result to the administrator terminal 2 by the information processing apparatus 4 will be mainly described.

### Configuration of the Information Processing Apparatus 4

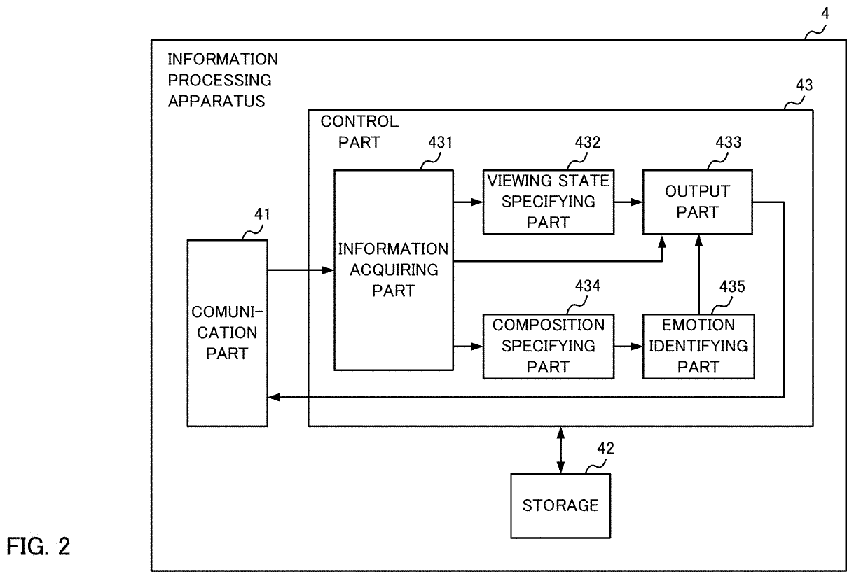

FIG. 2 shows a configuration of the information processing apparatus 4. The information processing apparatus 4 includes a communication part 41, a storage 42, and a control part 43. The control part 43 includes an information acquiring part 431, a viewing state specifying part 432, an output part 433, a composition specifying part 434, and an emotion identifying part 435.

The communication part 41 has a communication interface for transmitting and receiving data to and from the image providing device 1, the administrator terminal 2, or the viewing terminal 3 via the network N. The communication part 41 inputs, to the information acquiring part 431, the space image data received from the image providing device 1, and the selected image ID, the viewing time information, the looking state information, the biometric information or the like received from the viewing terminal 3. Further, the communication part 41 transmits data indicating the analysis result input from the output part 433 to the administrator terminal 2.

The storage 42 includes a storage medium such as a Read Only Memory (ROM), a Random Access Memory (RAM), and a hard disk. The storage 42 stores the space image data received from the image providing device 1 in association with space image identification information (hereinafter referred to as a “space image ID”) for identifying the space image data. Further, the storage 42 stores a program executed by the control part 43.

The control part 43 is a Central Processing Unit (CPU), for example. The control part 43 functions as the information acquiring part 431, the viewing state specifying part 432, the output part 433, the composition specifying part 434, and the emotion identifying part 435 by executing the program stored in the storage 42.

The information acquiring part 431 acquires various types of information received by the communication part 41. The information acquiring part 431 acquires the selected image ID, the viewing time information, the looking state information, or the biometric information transmitted by the viewing terminal 3, for example. The information acquiring part 431 inputs the acquired selected image ID, viewing time information, and looking state information to the viewing state specifying part 432. Further, the information acquiring part 431 inputs the acquired selected image ID and biometric information to the composition specifying part 434. The information acquiring part 431 may input at least a piece of the acquired information to the output part 433.

The information acquiring part 431 acquires a plurality of selected image IDs, viewing time information, looking state information, or biometric information corresponding to a plurality of viewers transmitted by a plurality of viewing terminals 3. The information acquiring part 431 may acquire these types of information in association with a viewer ID for identifying the viewer, or may acquire these types of information without associating them with the viewer ID.

The viewing state specifying part 432 specifies a viewing state (e.g., a viewing time or a gaze point) for each of one or more selected images selected by the viewer. The viewing state specifying part 432 notifies the output part 433 of the specified viewing state. The viewing state specifying part 432 aggregates viewing states for the plurality of space images corresponding to the plurality of selected image IDs received from the plurality of viewing terminals 3, and notifies the output part 433 of the aggregated result in association with the space image IDs.

The viewing state specifying part 432 specifies a time during which each selected image is continuously viewed, on the basis of the selected image IDs and the viewing time information input from the information acquiring part 431, for example. Further, the viewing state specifying part 432 specifies a point that the viewer looked at in each of the selected images and a time for which the viewer looked at each point, on the basis of the selected image IDs and the looking state information input from the information acquiring part 431. The viewing state specifying part 432 may specify statistics (e.g., an average value, a median value, a minimum value, or a maximum value) of a plurality of viewing times corresponding to the plurality of viewers on the basis of the selected image IDs and the viewing time information transmitted from the plurality of viewing terminals 3.

The viewing state specifying part 432 may specify, for each of a plurality of sets including two or more space images included in the plurality of space images, a shifting frequency, which is the number of times that two or more space images included in the set are continuously selected. The viewing state specifying part 432 specifies the order in which the viewer viewed the plurality of space images on the basis of the order in which the plurality of viewing terminals 3 transmitted the selected image IDs, for example. Then, the viewing state specifying part 432 counts the number of times that the second space image is selected after the first space image has been selected, as the shifting frequency.

For example, if 60 viewers viewed a space image of the hallway A after viewing a space image of the entrance, the viewing state specifying part 432 specifies the number of times of shifting from the entrance to the hallway A as 60. As another example, if 40 viewers viewed a space image of the hallway B after viewing a space image of the entrance, the viewing state specifying part 432 specifies the number of times of shifting from the entrance to the hallway B as 40.

On the basis of the specified shifting frequency, the viewing state specifying part 432 may specify the ratio at which the viewers have shifted among each of the sets including two space images. In the above-described example, the viewing state specifying part 432 specifies the ratio of shifting from the entrance to the hallway A as 60%, and the ratio of shifting from the entrance to the hallway B as 40%. The viewing state specifying part 432 notifies the output part 433 of the specified shifting frequency or ratio.

The output part 433 outputs one or more thumbnail images corresponding to one or more selected images, in a manner corresponding to the viewing state (e.g., a viewing time or a gaze point) specified by the viewing state specifying part 432. The thumbnail image is the same image as the space image, or a reduced image of the space image. The output part 433 outputs one or more pieces of thumbnail image data in a state where an image indicating an analysis result is superimposed on the one or more thumbnail images. For example, the output part 433 transmits thumbnail image data including the analysis result to the administrator terminal 2 requesting the analysis result, to cause the thumbnail image data to be displayed on the administrator terminal 2.

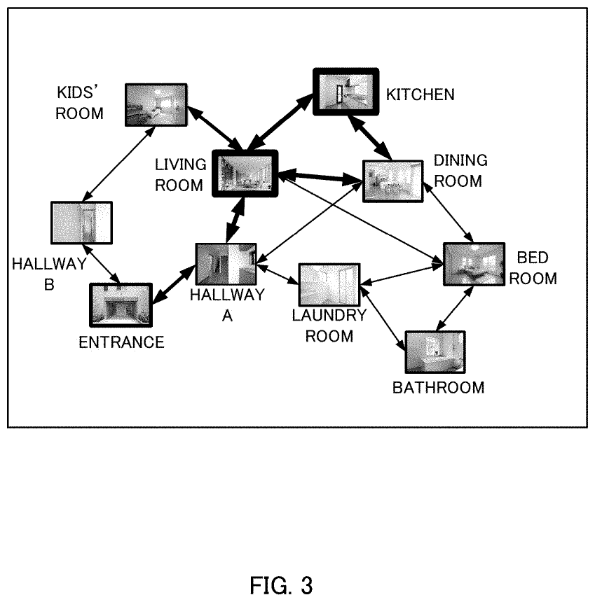

FIG. 3 shows an example of an image output by the output part 433. FIG. 3 shows a plurality of thumbnail images corresponding to a plurality of rooms in a building. The output part 433 displays a frame of a thumbnail image corresponding to a space image viewed for a long time by the viewer, in a manner to have a thicker frame than a thumbnail image corresponding to a space image viewed for a short time, for example.

In the example shown in FIG. 3, the frames of the space images of the living room and the kitchen are thicker than the frames of the space images of other rooms. This indicates that the viewing times of the space images of the living room and the kitchen by the viewer are longer than the viewing times of the space images of the other rooms. The output part 433 may output frames with different colors depending on the viewing times. In this way, the output part 433 outputs a thumbnail image in a manner corresponding to a viewing time. Due to this, the administrator who manages space images checks an analysis result including the thumbnail image, thereby making it easier to grasp the spaces corresponding to the space images that the viewer was interested in.

The output part 433 may switch between a first mode of outputting a plurality of thumbnail images in a manner corresponding to statistics of a plurality of viewing times corresponding to a plurality of viewers, and a second mode of outputting a plurality of thumbnail images in a manner corresponding to a viewing time corresponding to one viewer among the plurality of viewers. In the first mode, the output part 433 outputs the plurality of thumbnail images corresponding to a plurality of space images in a manner corresponding to statistics of the plurality of viewing times corresponding to the plurality of viewers, for example.

The output part 433 outputting such a thumbnail image makes it easier for the administrator who views the thumbnail image to grasp a trend about which space images, and therefore which spaces, many viewers have an interest in. For example, if it is determined that a large number of viewers do not look at ceiling lighting at all, since the administrator can confirm that simple lighting hardly affects a viewer's decision making, it is possible to make use of such information for determining the design of a building or space provided by the administrator.

On the other hand, in association with a viewer ID, the output part 433 outputs a plurality of thumbnail images in a manner corresponding to the length of the viewing time of the viewer for each space image corresponding to the viewer ID in the second mode. The output part 433 outputs the thumbnail image in association with the viewer ID in this manner. This allows a person in charge of selling to the viewer to provide various explanations to the viewer, after recognizing points in which the viewer has interest, for example.

Further, as shown in FIG. 3, the output part 433 may output a plurality of thumbnail images in a state where two or more thumbnail images corresponding to two or more space images are combined by a connecting line (e.g., a double headed arrow in FIG. 3) in a manner corresponding to the shifting frequency notified from the viewing state specifying part 432. In the example shown in FIG. 3, since the number of times that the viewer has shifted between the entrance and the hallway A is greater than the number of times that the viewer has shifted between the entrance and the hallway B, the output part 433 displays the connecting line between the entrance and the hallway A in a manner to be thicker than the connecting line between the entrance and the hallway B. Since the number of times that the viewer has shifted between the hallway A and the living room is greater than the number of times that the viewer has shifted between the entrance and the hallway A, the output part 433 displays the connecting line between the hallway A and the living room in a manner to be much thicker than the connecting line between the entrance and the hallway A. The output part 433 outputting such a connecting line allows the administrator who provides a space image to grasp the viewer's tendency of shifting. This makes it possible to improve arrangements of the space images such that the viewer shifts as expected by the administrator, and to give a feedback on the design of the building by grasping the flow of shifting.

FIG. 3 shows a case where the output part 433 displays a connecting line that becomes thicker as the number of times that the viewer shifts their view along any one of a plurality of directions increases, regardless of the direction in which the viewer shifts their view between the two space images, but the output part 433 may output different connecting lines for each direction. In this case, if the number of times that the viewer shifts their view from the hallway A to the living room is greater than the number of times that the viewer shifts their view from the living room to the hallway A, the output part 433 makes the connecting line from the hallway A to the living room thicker than the connecting line from the living room to the hallway A. The output part 433 outputting such a connecting line allows the administrator who provides the space image to more accurately grasp the viewer's tendency of shifting their view among the space images viewed by the viewer.

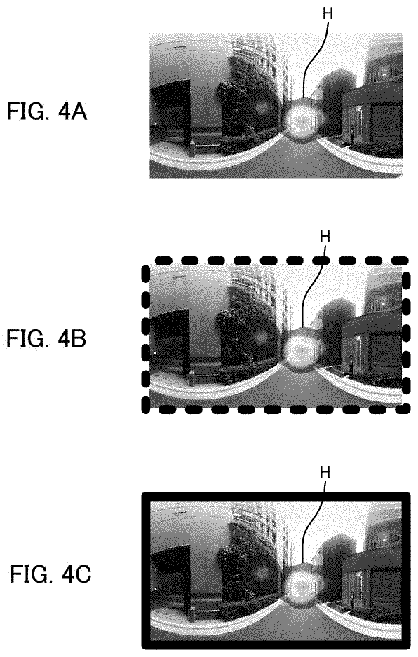

FIGS. 4A to 4C show other examples of the thumbnail images output by the output part 433. As shown in FIG. 4A, the output part 433 may output a looking state display image H in a manner corresponding to a looking time, onto a gaze point in one or more thumbnail images or enlarged images of the one or more thumbnail images. The looking state display image H is an image of a predetermined color indicating a point looked at by the viewer. The output part 433 may output the looking state display image H with different colors or different patterns in accordance with the length of time for which each of the gaze points are looked at, onto the thumbnail images or the enlarged images. The looking state display image H in this case is a so-called heat map image, and the administrator who provides the space image can easily grasp which location in the space image the viewer is interested in by checking the looking state display image H.

The output part 433 may output the looking state display image H in a manner corresponding to a result of weighting the looking time on the basis of biometric information acquired by the information acquiring part 431 from the viewing terminal 3. For example, if the biometric information obtained while the viewer is looking at the gaze point for a looking time equal to or greater than a threshold indicates that the viewer is relaxed, the output part 433 outputs a looking state display image H in a manner corresponding to a looking time longer than the actual looking time.

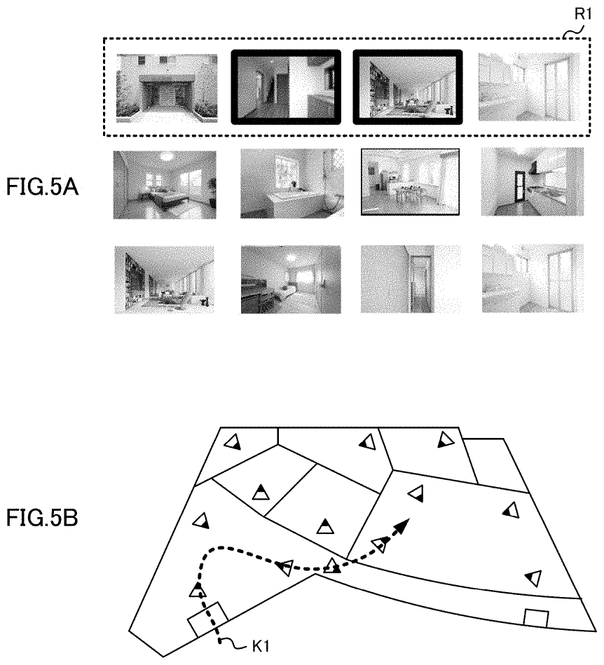

As an example, the output part 433 may output a thumbnail image or a looking state display image H as shown in FIGS. 5A and 5B in a different manner depending on the degree to which the viewer viewing the space image is relaxed. For example, the output part 433 displays a broken-line frame as shown in FIG. 4B when the viewer is relaxed, and displays a solid-line frame as shown in FIG. 4C if the degree of being relaxed is improved. The output part 433 may display a red frame when the viewer is relaxed, and change the color of the frame if the degree of being relaxed is improved to make the frame closer to blue, for example.

In contrast, if the biometric information obtained while the viewer is looking at the gaze point for a looking time equal to or greater than a threshold is equivalent to the biometric information of the viewer in a normal state, the output part 433 may output the looking state display image H in a manner corresponding to a looking time shorter than the actual looking time. In this manner, the output part 433 outputs the looking state display image H generated by weighting the looking time on the basis of the biometric information, thereby making it easier for the administrator who manages the space image to further grasp a location that the viewer is interested in.

It should be noted that the timing when the output part 433 updates a thumbnail image including an analysis result is arbitrary, but the output part 433 updates the analysis result each time the information acquiring part 431 receives a new selected image ID, viewing state information, or the like, for example. Since the information acquiring part 431 receives the selected image ID and the viewing state information from a number of viewing terminals 3, the output part 433 updates the analysis result substantially in real time. The output part 433 operating in this manner allows the administrator using the administrator terminal 2 to check the latest state of the viewer.

### Identification of Viewer's Emotion on the Basis of Composition

The composition specifying part 434 specifies a composition included in a space image. For example, the composition specifying part 434 extracts an outline included in the space image stored in advance in the storage 42 in association with the space image ID corresponding to the selected image ID acquired from the information acquiring part 431, and then specifies, on the basis of the extracted outline, whether each region in the space image is a region including a one-point perspective composition or a region including a two-point perspective composition. The one-point perspective composition is a composition having only one vanishing point. The two-point perspective composition has two vanishing points. The composition specifying part 434 notifies the emotion identifying part 435 of the specified composition. The composition specifying part 434 may notify the emotion identifying part 435 of the specified composition, in association with coordinate information indicating a position in the space image.

The emotion identifying part 435 identifies an emotion that the viewer had with respect to the space image on the basis of a relationship between the composition specified by the composition specifying part 434 and a gaze point indicated by the looking state information. For example, if it is determined that the viewer looks at a region specified as including the one-point perspective composition by the composition specifying part 434, the emotion identifying part 435 identifies that the viewer has a sense of security. On the other hand, if it is determined that the viewer looks at the region specified as including the two-point perspective composition by the composition specifying part 434, the emotion identifying part 435 identifies that the viewer has a sense of openness. The emotion identifying part 435 notifies the output part 433 of the identified emotion of the viewer.

The emotion identifying part 435 may further use other information when identifying the viewer's emotion with respect to the space image. For example, the emotion identifying part 435 may acquire biometric information acquired while the viewer views the space image, from the information acquiring part 431, and may identify the viewer's emotion on the basis of the acquired biometric information. For example, if the heart rate of the viewer increases, the emotion identifying part 435 identifies that the viewer was greatly interested in the space image viewed by the viewer.

Further, the emotion identifying part 435 may identify the viewer's emotion on the basis of the movement of the viewer's line of sight while the viewer views the space image. If the viewer performs “checking” to continue looking at the same looking target for a predetermined time (e.g., 0.2 seconds or more and less than one second), the emotion identifying part 435 identifies that the viewer cannot grasp what the looking target is. If the viewer performs “watching” to continue looking at the same looking target for a predetermine time or more (e.g., one second or more), the emotion identifying part 435 identifies that the viewer has great interest in the looking target. If the viewer performs “glancing” to look at the same looking target for a short time (e.g., 0.2 second or less) and then repeatedly look at other looking targets only for a short time, the emotion identifying part 435 identifies that the viewer has no interest in the looking target.

The output part 433 outputs one or more thumbnail images in a manner corresponding to an emotion identified by the emotion identifying part 435. For example, the output part 433 outputs a plurality of thumbnail images in a state where the plurality of thumbnail images are surrounded by frames in a manner corresponding to a case where the viewer is specified as having a sense of security and a case where the viewer is specified as having a sense of openness, respectively. The output part 433 may output only the thumbnail image corresponding to the space image whose composition was able to be specified by the composition specifying part 434, in a manner corresponding to the viewer's emotion.

In the thumbnail image, the output part 433 may output an image indicating a region in which the one-point perspective composition or the two-point perspective composition was specified by the composition specifying part 434, onto the thumbnail image. The output part 433 outputs information indicating the viewer's emotion in association with the thumbnail image. Due to this, the administrator who provides a space image can design a building for the viewer or provide an explanation in accordance with the viewer's emotion by referencing the viewer's emotion when the viewer viewed the space image.

### Displaying a Layout Diagram

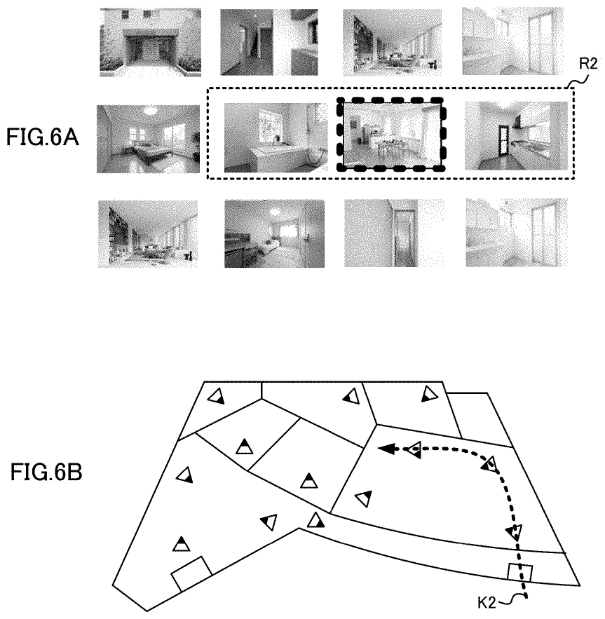

The output part 433 may cause the administrator terminal 2 to display a layout diagram showing the layout of the space corresponding to the space image, together with the thumbnail image. FIGS. 5A, 5B, 6A, and 6B show examples of a screen including thumbnail images and layout diagrams displayed by the administrator terminal 2. FIGS. 5A and 6A show thumbnail images, and FIGS. 5B and 6B show layout diagrams. A triangular symbol in the layout diagram indicates a point at which a space image was captured, and a black portion therein indicates a photographing direction.

Broken-line arrows in FIGS. 5B and 6B indicate routes input by the administrator of the administrator terminal 2. The information acquiring part 431 acquires route information indicating the route input by the administrator, and notifies the output part 433 of the acquired route information. The output part 433 outputs information for specifying one or more thumbnail images corresponding to one or more space images corresponding to the route indicated by the route information, among a plurality of space images.

In the example shown in FIGS. 5A and 5B, the administrator inputs the route K1 shown in FIG. 5B, and the output part 433 causes the administrator terminal 2 to display the broken line R1 surrounding a plurality of thumbnail images corresponding to the route K1 as shown in FIG. 5A. Since the output part 433 outputs information for specifying the thumbnail image corresponding to the route in this manner, the administrator who manages the space images can easily check the thumbnail image of the place about which the administrator wants to check the user's impression.

In the example shown in FIGS. 6A and 6B, the administrator inputs the route K2 shown in FIG. 6B, and the output part 433 causes the administrator terminal 2 to display the broken line R2 surrounding a plurality of thumbnail images corresponding to the route K2 as shown in FIG. 6A. Some thumbnail images shown in FIGS. 5A, 5B, 6A, and 6B are surrounded by frames in a manner corresponding to a length of time that the viewer views the thumbnail images and the viewer's emotion, for example. Since the output part 433 outputs an image in a manner corresponding to the length of time that the viewer viewed the thumbnail images and the viewer's emotion together with the layout diagram and the thumbnail image, the administrator can easily grasp what kind of impression the viewer had at which place.

Further, the administrator checks the viewing time and the viewer's emotion displayed on the thumbnail image while changing a route to be input in the layout diagram. Due to this, the administrator can check which routes to rooms made the viewer more relaxed in entering the rooms. For example, in a case where the solid-line frame shown in FIG. 5A indicates that the viewer has a sense of security and the broken-line frame shown in FIG. 6B indicates that the viewer has a sense of openness, the administrator can confirm that the route K2 shown in FIG. 6B is more suitable as a route for viewing a room, where the administrator wants to emphasize its openness. The output part 433 may display only a route that is likely to result in closing a deal among several types of routes, or may highlight the route that is likely to result in closing a deal.

### Optimizing Arrangements of Operation Icons

In the information processing system S, the viewer can perform an operation for viewing additional information and accessing an external link, such as an electronic commerce site, while viewing a space image. For this purpose, the viewing terminal 3 displays an icon image for the viewer to perform a predetermined operation onto the space image. In this case, in order to increase the probability that the viewer operates the icon image, it is desirable to arrange the icon image at a location that ensures a high probability of being looked at by the viewer.

Here, the output part 433 may determine a location at which to arrange the icon image for receiving a predetermined operation from the viewer, and may output data indicating the determined location on the basis of a looking time at a point where the viewer looked at in a plurality of space images. Specifically, the output part 433 determines to arrange the icon image at a location that is looked at by a large number of viewers for a relatively long time, and transmits the coordinates of the determined location to the administrator terminal 2 in association with the space image ID. The output part 433 may output image data in a state where a predetermined symbol is superimposed on the space image data or the thumbnail image data to the administrator terminal 2.

The administrator of the administrator terminal 2 generates space image data in which the icon image is arranged at the location indicated by the data output by the output part 433, and transmits the generated space image data to the viewing terminal 3. The output part 433 operating in this manner causes the space image, in which the icon images for receiving the operation are arranged, to be displayed at a location where it is easy for the viewer to look at on the viewing terminal 3, thereby increasing the probability that the viewer performs the operation using the icon image. Accordingly, the probability that a product is purchased or the probability that other sites are accessed is increased by the operation using the icon image, for example.

### Comparison By Difference in Photographing Viewpoint

Even an image obtained by photographing one space provides the viewer with different impressions depending on a photographing position and a photographing direction. Here, the information processing apparatus 4 may output a plurality of thumbnail images in a manner corresponding to a viewing time of each of a plurality of space images with different photographing positions or photographing directions, or to the viewer's emotion identified by the emotion identifying part 435, so that the administrator can check which space image, and therefore which position and direction, is desirable.

In this case, the information acquiring part 431 acquires first selected image identification information corresponding to a first space image corresponding to one space, and second selected image identification information, corresponding to this one space, corresponding to a second space image with a photographing position or photographing direction different from that of the first space image. The viewing state specifying part 432 specifies a first viewing time of the first space image and a second viewing time of the second space image. The output part 433 outputs a first thumbnail image corresponding to the first space image associated with the first selected image identification information in a manner corresponding to the first viewing time, and outputs a second thumbnail image corresponding to the second space image associated with the second selected image identification information in a manner corresponding to the second viewing time.

By comparing the state of the first thumbnail image and the state of the second thumbnail image, the administrator can determine to continuously use a space image corresponding to the thumbnail image viewed for a long time, and to stop using the other space image, for example. As a result, it is possible to cause the viewing terminal 3 to display a space image that leads to an increasing number of closed deals for real estate sales and rent, and to an increasing transaction rate of product sales.

### Outputting Weekly Analysis Result

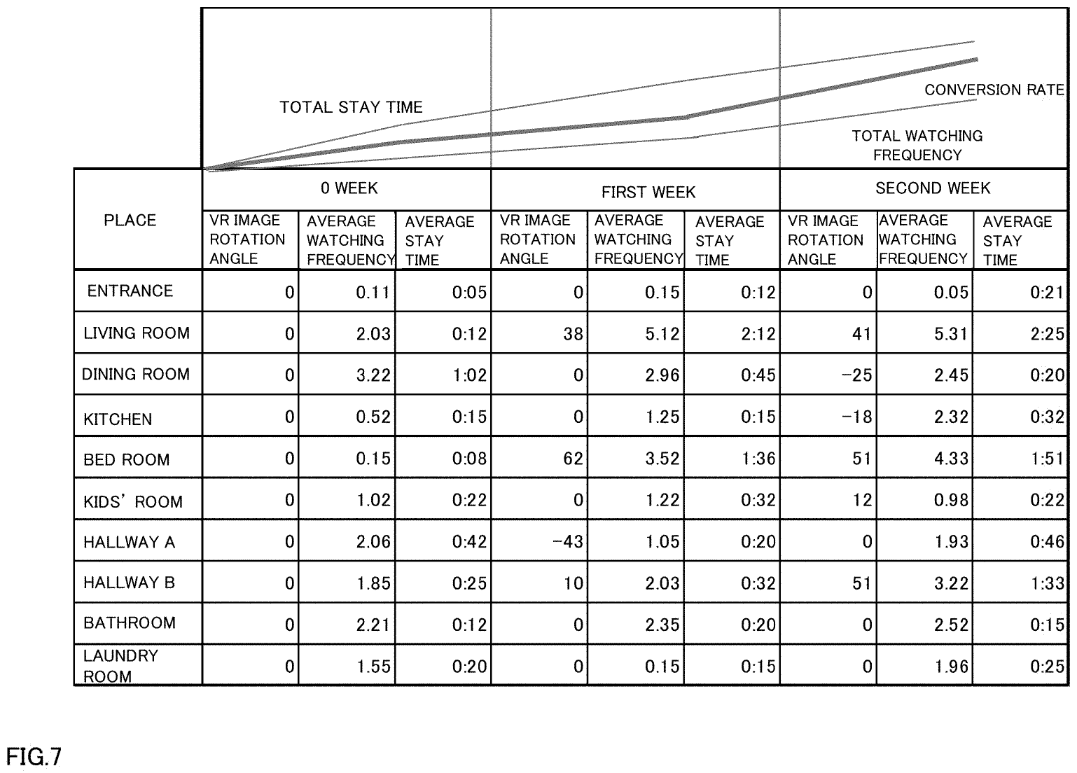

The output part 433 may output analysis results at a predetermined time interval (e.g., weekly intervals). FIG. 7 shows an example of a weekly analysis results output by the output part 433.

Error! Unknown switch argument. The table in FIG. 7 shows an area in which each of a plurality of space images (VR images) is associated with an angle of the space image, an average watching frequency of the viewer, and an average stay time of the viewer on a weekly basis. Further, the upper portion of the table shows a change in the total stay time of the viewer and conversion rate (the rate of the number of transactions made with the viewers). The number of transactions is a part or all of the number of times of receiving a documented request, the number of times of receiving a query, or the number of times of a purchase being made. The space image may include an icon image for querying about or purchasing a product or service, and the number of times that the icon image is pressed may be the number of transactions. The output part 433 calculates the conversion rate by adding or multiplying the average watching frequency and the average stay time, for example.

As shown in FIG. 7, as the angle of the space image changes, the average watching frequency and the average stay time also change. As a result, the conversion rate changes too. The operator who manages the image providing device 1 checks the analysis result as shown in FIG. 7 to optimize the angle of the space image, thereby making it possible to adjust the angle of each space image so as to improve the conversion rate. In particular, since the output part 433 shows an analysis result in which the conversion rate, the average watching frequency, and the average stay time corresponding to each space image are associated with each other, as shown in FIG. 7, the operator who manages the image providing device 1 can easily determine which space image should be altered to improve the conversion rate.

### Flow of Processing in the Information Processing System S

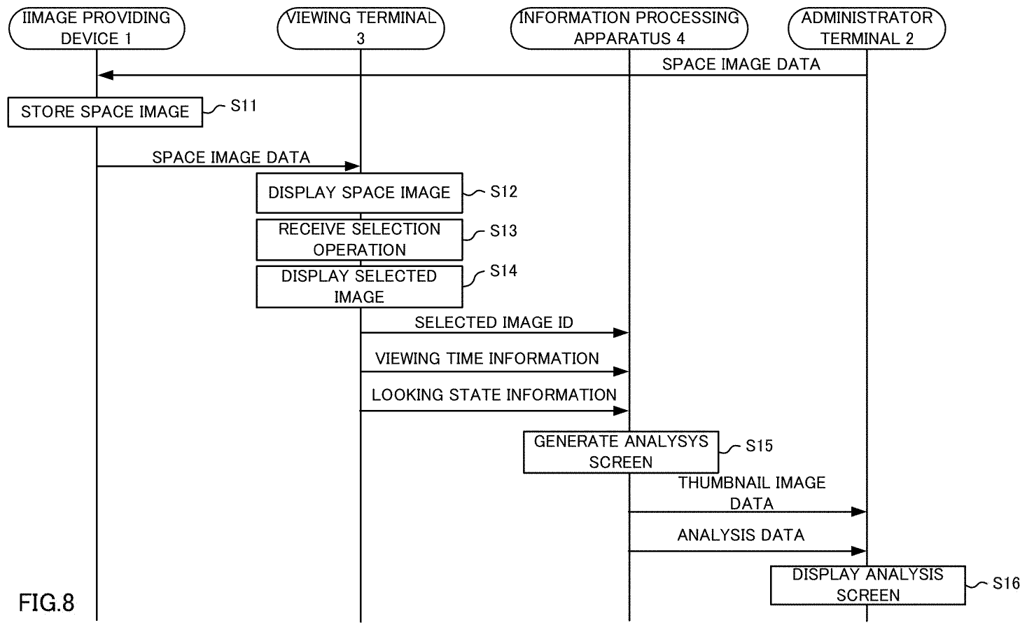

FIG. 8 is a sequence diagram showing a flow of processing in the information processing system S. The sequence diagram shown in FIG. 8 starts at the time when the administrator terminal 2 transmits a space image data to the image providing device 1. The image providing device 1 stores a plurality of space images received from the administrator terminal 2 in a storage medium (e.g., a hard disk) (S11). The image providing device 1 transmits the stored space image data and script to the viewing terminal 3 by being accessed from the viewing terminal 3.

Upon receiving the space image data, the viewing terminal 3 displays a plurality of space images (S12). The viewing terminal 3 receives an operation of selecting a space image by the viewer (S13), and displays the selected image (S14). Further, the viewing terminal 3 transmits a selected image ID, viewing time information, and looking state information of the selected image to the information processing apparatus 4 by executing the script.

In the information processing apparatus 4, the output part 433 generates an analysis screen (e.g., the screens shown in FIGS. 3 to 7) including a plurality of pieces of thumbnail image data and analysis data used for analysis by the administrator (S15). The analysis data is image data indicating a viewing time, a point looked at by the viewer, an emotion of the viewer, or the like, for example. The information processing apparatus 4 transmits the thumbnail image data and the analysis data to the administrator terminal 2. The administrator terminal 2 displays the analysis screen including the received thumbnail image data and analysis data (S16).

### Modified Example

In the above description, the output part 433 outputs, to the administrator terminal 2, an analysis screen including a plurality of pieces of thumbnail image data and analysis data used for analysis by the administrator, but the output part 433 may provide the viewer with information that meets the viewer's need specified on the basis of the analysis result. Specifically, the output part 433 may specify the thoughts of the viewer with respect to a building, space, product in the space, or the like corresponding to the space image, on the basis of a selected image ID, viewing time information, and operation location information or looking state information acquired by the information acquiring part 431, and may output advertising information selected on the basis of the specified thoughts of the viewer to a terminal used by the viewer.

As an example, if the viewing terminal 3 is a terminal owned by a company, which is a viewer, the output part 433 specifies the thoughts of the viewer on the basis of the selected image ID, the viewing time information, the operation location information, or the looking state information acquired by the information acquiring part 431, and transmits the advertising information selected on the basis of the thoughts of the viewer to the viewing terminal 3. The advertising information may be presented in any manner as long as the advertising information is about a building, a space, a product in the space, or the like corresponding to the space image, and is transmitted to the viewing terminal 3 via email, an email newsletter, or a website viewed by the viewer, for example. The thoughts of the viewer refer to which location or product the viewer is interested in, the degree to which the viewer wants to purchase them, or the like.

The image providing device 1 may record cookie including the selected image ID, the viewing time information, the operation location information, or the looking state information on the browser of the viewing terminal 3, in addition to or instead of executing the script on the viewing terminal 3. The information acquiring part 431 acquires information included in the cookie if the viewing terminal 3 accesses a site provided by the image providing device 1, and provides advertising information selected on the basis of the acquired information to the image providing device 1, thereby causing the viewing terminal 3 to display the advertising information via the image providing device 1. Having the information processing apparatus 4 and the image providing device 1 operate in this manner makes it possible to make use of a result obtained by grasping what kind of impression the customer, who is the viewer, has for a predetermined building, space, or product in the space for marketing.

### Effect of the Information Processing System S

As described above, the viewing state specifying part 432 specifies a viewing time of each of one or more selected images selected by the viewer with respect to each of a plurality of space images, and the output part 433 outputs one or more thumbnail images corresponding to the one or more selected images together with an analysis result in a manner corresponding to the viewing time specified by the viewing state specifying part 432. Since the information processing apparatus 4 configured in this manner allows the administrator who manages the space images to see the thumbnail image including the analysis result, the administrator can easily know which space images the viewer has continuously viewed and for how long the viewer has viewed these space images. As a result, the administrator can easily grasp what kind of impression the customer, who is the viewer, has for a building or a space, and thus can increase the transaction rate by improving the space image to be viewed by the viewer or by providing an explanation suitable for the viewer.

The present disclosure is explained on the basis of the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Further, new exemplary embodiments generated by arbitrary combinations of them are included in the exemplary embodiments. Further, effects of the new exemplary embodiments brought by the combinations also have the effects of the original exemplary embodiments.

What is claimed is:

1. An information processing apparatus comprising:
an information acquiring part that acquires selected image identification information for identifying one or more selected images selected from a plurality of space images, corresponding to a plurality of regions in a space to be looked at from a plurality of positions in the space, by a viewer who views the plurality of space images;
a viewing state specifying part that specifies a viewing time of each of the one or more selected images selected by the viewer; and
an output part that outputs one or more thumbnail images corresponding to the one or more selected images in a manner corresponding to the viewing time.

2. The information processing apparatus according to claim 1, wherein
the information acquiring part further acquires looking state information indicating gaze points, which are points that the viewer looked at in the space image, and looking times, each of which is a time for which a respective one of the gaze points was looked at, and
the output part outputs a looking state display image in a manner corresponding to the looking time onto the gaze point in the one or more thumbnail images or an enlarged image of the one or more thumbnail images.

3. The information processing apparatus according to claim 2, wherein
the information acquiring part further acquires biometric information of the viewer while the viewer is viewing the space image, and
the output part outputs the looking state display image in a manner corresponding to a result of weighting the looking time on the basis of the biometric information.

4. The information processing apparatus according to claim 2, wherein
the output part determines a location at which to arrange an icon image for receiving a predetermined operation from the viewer, on the basis of the looking time at a point looked at by the viewer in the plurality of space images, and outputs data indicating the determined location.

5. The information processing apparatus according to claim 1, wherein
the information acquiring part further acquires looking state information indicating a gaze point, which is a point that the viewer looked at in the space image;
the information processing apparatus further includes:
a composition specifying part that specifies a composition included in the space image; and
an emotion identifying part that identifies an emotion of the viewer with respect to the space image on the basis of a relationship between the composition specified by the composition specifying part and the gaze point indicated by the looking state information, and
the output part outputs the one or more thumbnail images in a manner corresponding to the emotion identified by the emotion identifying part.

6. The information processing apparatus according to claim 1, wherein
the information acquiring part acquires a plurality of pieces of the selected image identification information corresponding to a plurality of the viewers, and
the output part outputs a plurality of the thumbnail images corresponding to the plurality of space images in a manner corresponding to statistics of a plurality of the viewing times corresponding to the plurality of viewers.

7. The information processing apparatus according to claim 6, wherein
the viewing state specifying part specifies, for each of a plurality of sets including two or more space images included in the plurality of space images, a shifting frequency, which is the number of times that the two or more space images included in the set are continuously selected, and
the output part outputs the plurality of thumbnail images in a state where two or more thumbnail images corresponding to the two space images are combined by a connecting line in a manner corresponding to the shifting frequency.

8. The information processing apparatus according to claim 6, wherein
the output part switches between a first mode of outputting the plurality of thumbnail images in a manner corresponding to statistics of the plurality of viewing times corresponding to the plurality of viewers, and a second mode of outputting the plurality of thumbnail images in a manner corresponding to the viewing time corresponding to one viewer among the plurality of viewers.

9. The information processing apparatus according to claim 1, wherein
the output part outputs the thumbnail image onto a layout diagram showing a layout of the space,
the information acquiring part further acquires route information indicating a route selected in the layout diagram, and
the output part outputs information for specifying one or more thumbnail images corresponding to one or more space images corresponding to the route indicated by the route information, among the plurality of space images.

10. The information processing apparatus according to claim 1, wherein
the information acquiring part acquires first selected image identification information corresponding to a first space image corresponding to one space, and second selected image identification information, corresponding to the one space, corresponding to a second space image with a photographing position or photographing direction different from that of the first space image,
the viewing state specifying part specifies a first viewing time of the first space image and a second viewing time of the second space image, and
the output part outputs a first thumbnail image corresponding to the first space image associated with the first selected image identification information in a manner corresponding to the first viewing time, and outputs a second thumbnail image corresponding to the second space image associated with the second selected image identification information in a manner corresponding to the second viewing time.

11. The information processing apparatus according to claim 1, wherein
the information acquiring part further acquires viewing time information indicating a time for which the selected image selected by the viewer was displayed on the viewing terminal, and operation location information indicating a location that the viewer operated on the viewing terminal, or looking state information indicating a point that the viewer looked at, and
the output part specifies thoughts of the viewer with respect to a space or a product corresponding to the space image on the basis of the selected image identification information, the viewing time information, and the operation location information, or the looking state information acquired by the information acquiring part, and outputs advertising information selected on the basis of the specified thoughts of the viewer to a terminal used by the viewer.

12. An information processing method, executed by a computer, comprising the steps of:
acquiring selected image identification information for identifying one or more selected images selected from a plurality of space images, corresponding to a plurality of regions of a space to be looked at from a plurality of positions in the space, by a viewer who views the plurality of space images;
specifying a viewing time of each of the one or more selected images selected by the viewer; and
outputting one or more thumbnail images corresponding to the one or more selected images in a manner corresponding to the viewing time.

13. A non-transitory storage medium storing a program for causing a computer to function as:
an information acquiring part that acquires selected image identification information for identifying one or more selected images selected from a plurality of space images, corresponding to a plurality of regions in a space to be looked at from a plurality of positions in the space, by a viewer who views the plurality of space images;
a viewing state specifying part that specifies a viewing time of each of the one or more selected images selected by the viewer; and
an output part that outputs one or more thumbnail images corresponding to the one or more selected images in a manner corresponding to the viewing time.
